(19) United States
(12) Patent Application Publication
(10) Pub. No.: US 2020/0353563 A1
(43) Pub. Date: Nov. 12, 2020

(54) LASER PROCESSING METHOD FOR PLASTIC FILM, AND PLASTIC FILM

(71) Applicant: NITTO DENKO CORPORATION, Ibaraki-shi, Osaka (JP)

(72) Inventor: Naoyuki Matsuo, Ibaraki-shi (JP)

(73) Assignee: NITTO DENKO CORPORATION, Ibaraki-shi, Osaka (JP)

(21) Appl. No.: 16/766,898

(22) PCT Filed: Nov. 26, 2018
(86) PCT No.: PCT/JP2018/043354

§ 371 Date: May 26, 2020

(30) Foreign Application Priority Data
Nov. 27, 2017 (JP) 2017-226441

(51) Int. Cl. B23K 26/082; B23K 26/402

(52) U.S. Cl. CPC B23K 26/082; B23K 26/38; B23K 26/402

(57) ABSTRACT

A laser processing method is disclosed which is capable of easily reducing contamination on a plastic film surface, and also capable of cutting a plastic film in a free-form shape. A laser processing method includes a process of pulsing a laser beam L having a wavelength in the infrared region from a laser beam source 1 and causing a plastic film F to be irradiated with the laser beam L to cut the plastic film. The peak energy density of the laser beam with which the plastic film is irradiated is 70 J/cm² or more and 270 J/cm² or less.

### TECHNICAL FIELD

The present invention relates to a laser processing method for cutting a plastic film such as an optical film using a laser beam, and to a plastic film obtained using the laser processing method. In particular, the present invention relates to a laser processing method which is capable of easily reducing contamination on a plastic film surface caused by adherence to the plastic film surface of scattered matter that arises when performing laser processing of a plastic film and which is also capable of cutting a plastic film into a free-form shape, and also relates to a plastic film obtained using the laser processing method.

### BACKGROUND ART

In recent years, optical films such as a polarizing film are used not only for televisions and personal computers, but also for diverse display uses such as smartphones, smartwatches and vehicle-mounted displays.

Therefore, the shapes required for optical films are becoming complex and free-form, and high dimensional accuracy is also required.

Known methods for irregular shape processing for cutting into various shapes other than rectangles include end milling, punching, profile milling and laser processing.

Among these various irregular shape processing methods, a laser processing method has the excellent advantages of easily corresponding to cutting of shapes that are complex and free form, and also easily obtaining high dimensional accuracy as well as being excellent in processing quality.

However, in the case of the laser processing method, there is the problem that scattered matter which arises as a result of the workpiece melting and gasifying at the cutting position adheres to the optical film surface and thus causes contamination of the optical film surface. This is a common problem for all kinds of plastic films including optical films.

A method whereby scattered matter is sucked in and collected by a dust collector is conceivable as a method for solving the kind of problem described above. However, according to such a method, scattered matter located in the vicinity of the cutting position of the plastic film cannot be efficiently sucked in.

A method disclosed in Patent Literature 1 has been proposed to solve the problem described above.

The method disclosed in Patent Literature 1 is a method in which a protective sheet for laser processing that has specific characteristics is attached to a workpiece such as a plastic film, laser processing is then performed, and thereafter the protective sheet is peeled off (claim 1 and the like of Patent Literature 1).

According to the method disclosed in Patent Literature 1, although it is possible to reduce contamination of the surface of a workpiece, time and labor are required to attach and peel off the protective sheet for laser processing, and the manufacturing cost also increases due to use of the protective sheet.

A method disclosed in Patent Literature 2 has also been proposed to solve the kind of problem described above.

The method disclosed in Patent Literature 2 is a laser processing method in which is a workpiece such as a plastic film is irradiated with a laser beam in a state in which the optical axis of the laser beam is tilted in an advancing direction of the processing at a prescribed angle with respect to a direction perpendicular to the surface of the workpiece (claim 1 and the like of Patent Literature 2).

According to the method disclosed in Patent Literature 2, although contamination of the workpiece surface can be reduced, the method cannot be used to cut a plastic film in a free-form shape since the method can only be applied to a case where a laser beam and a workpiece are scanned in only one direction relative to each other.

### CITATION LIST

### Patent Literature

[Patent Literature 1] JP2006-192478A

[Patent Literature 2] JP2008-302376A

### SUMMARY OF INVENTION

### Technical Problem

The present invention has been made to solve the problem of the prior art that is described above, and an object of the present invention is to provide a laser processing method which is capable of easily reducing contamination of a plastic film surface that is caused by adherence to the plastic film surface of scattered matter which arises when performing laser processing of the plastic film, and which is also capable of cutting a plastic film in a free-form shape.

### Solution to Problem

As a result of intensive studies conducted by the present inventors to solve the aforementioned problem, the present inventors discovered that in a case where a laser beam having a wavelength in the infrared region is pulsed and causes a plastic film to be irradiated with the laser to cut the plastic film, it is possible to easily reduce contamination of the plastic film surface by setting a peak energy density of the laser beam with which the plastic film is irradiated in a predetermined range, and thereby completed the present invention.

That is, to solve the aforementioned problem, a first means of the present invention provides a laser processing method for a plastic film, comprising: a process of pulsing a laser beam having a wavelength in an infrared region and causing a plastic film to be irradiated with the laser beam to cut the plastic film, wherein a peak energy density of the laser beam with which the plastic film is irradiated is 70 J/cm² or more and 270 J/cm² or less.

The term “peak energy density” in the first means of the present invention represents a value obtained by dividing the pulse energy of a laser beam with which a plastic film is irradiated by the area of the laser beam (laser spot) with which a plastic film is irradiated and multiplying the resultant value by two. In a case where the surface of the plastic is irradiated with the laser beam in a direction perpendicular to the surface, the area of the laser beam is calculated by multiplying the circular constant by (spot diameter/2)². The term “spot diameter” of a laser beam means a distance between positions at which the intensity of the laser beam is 1/e² times (approximately 13.5%) the peak intensity of the laser beam. The term “pulse energy” means the energy possessed by a single pulse of the laser beam, and is a value calculated by dividing the power of the laser beam with which a plastic film is irradiated by the repetition frequency (equivalent to the number of pulses of the oscillated laser beam per unit time).

If the peak energy density of a laser beam with which a plastic film is irradiated is too low, specifically, is less than 70 J/cm², a temperature increase accompanying infrared absorption of the plastic film will be insufficient. Consequently, scattered matter in which a large amount of melted components are included will arise at the cutting position. It is considered that because the kinetic energy of scattered matter in which a large amount of melted components are included is small, the scattered matter adheres to the plastic film surface in the vicinity of the cutting position and becomes a contamination source.

According to the first means of the present invention, because the peak energy density of the laser beam with which the plastic film is irradiated is 70 J/cm² or more, a temperature increase accompanying infrared absorption of the plastic film is activated. By this means, the kinetic energy of scattered matter that arises when the plastic film melts and gasifies increases, and it is possible to reduce scattered matter that adheres to the plastic film surface in the vicinity of the cutting position. As a result, contamination of the plastic film surface can be reduced. Note that, because scattered matter whose kinetic energy increases becomes fumes and is blown far away from the cutting position, for example, it is possible to effectively collect the scattered matter by sucking in the scattered matter using a dust collector.

On the other hand, if the peak energy density of the laser beam with which the plastic film is irradiated is too high, specifically is more than 270 J/cm², there is a risk that, particularly in a case where the plastic film is a laminated film composed of multiple layers, delamination will occur and will lead to a decrease in the quality of the plastic film end face at the cutting position.

According to the first means of the present invention, because the peak energy density of the laser beam with which a plastic film is irradiated is 270 J/cm² or less, there is no risk of the laser beam leading to a decrease in the quality of the plastic film end face at the cutting position.

As described above, according to the first means of the present invention, because the peak energy density of a laser beam with which a plastic film is irradiated is 70 J/cm² or more and 270 J/cm² or less, scattered matter that adheres to the plastic film surface in the vicinity of the cutting position decreases and it is possible to reduce contamination of the plastic film surface, and there is also no risk of causing a decrease in the quality of the plastic film end face at the cutting position.

According to the first means of the present invention, since time and labor are not required for attaching and peeling off a protective sheet for laser processing as in the method disclosed in Patent Literature 1, contamination of a plastic film surface can be easily reduced.

Further, according to the first means of the present invention, because there is no constraint regarding a need to place the optical axis of the laser beam in a state in which the optical axis is tilted in the advancing direction of the processing at a prescribed angle with respect to a direction perpendicular to the surface of the plastic film as in the method disclosed in Patent Literature 2, it is possible to cut a plastic film in a free-form shape as necessary.

In the first means of the present invention, in order to cut a plastic film it is necessary to condense the emitted laser beam into a laser spot having a predetermined spot diameter or less (for example, φ200 μm or less). In the first means of the present invention, in a case where the peak energy density of the laser beam with which a plastic film is irradiated satisfies the condition of being 70 J/cm² or more and 270 J/cm² or less, and furthermore the emitted laser beam is condensed into a laser spot having a predetermined spot diameter or less, a pulse energy of the laser beam with which the plastic film is irradiated is preferably 3.4 mJ/pulse or more and 8 mJ/pulse or less.

Further, as a result of intensive studies conducted by the present inventors to solve the aforementioned problem, the present inventors discovered that, with respect to a plastic film in which at least a protective film, an adhesive and a base material are laminated in that order, in a case where the plastic film is cut by irradiating the plastic film with a laser beam having a wavelength in the infrared region that is pulsed from the protective film side, scattered matter that contaminates the protective film surface is derived from the adhesive. Specifically, in a case where the adhesive was an acrylic adhesive, when the present inventors analyzed scattered matter that adhered to the protective film surface by Fourier transform infrared spectroscopy (FT-IR), the present inventors found that the absorbance had a peak at a wavelength corresponding to carboxylic acid that was derived from the acrylic adhesive. Thus, because scattered matter that adheres to the protective film surface is derived from the adhesive, the present inventors discovered that if a thickness of the adhesive is made thin, it is possible to easily reduce contamination of the plastic film surface, and thereby completed the present invention.

That is, to solve the aforementioned problem, a second means of the present invention provides a laser processing method for a plastic film, comprising: a process of, with respect to a plastic film in which at least a protective film, an adhesive and a base material are laminated in that order, pulsing a laser beam having a wavelength in an infrared region from the protective film side and causing the plastic film to be irradiated with the laser beam to cut the plastic film, wherein a thickness of the adhesive is 20 μm or less.

According to the second means of the present invention, because the thickness of the adhesive that is a primary cause of scattered matter that adheres to the outermost surface on the laser beam irradiation side is a thin thickness of 20 μm or less, it is possible to reduce contamination of the plastic film surface. Preferably, the thickness of the adhesive is made 15 μm or less.

Note that, in the second means of the present invention also, similarly to the first means, preferably the peak energy density of the laser beam with which the plastic film is irradiated is 70 J/cm² or more and 270 J/cm² or less. Also, a pulse energy of the laser beam with which the plastic film is irradiated is preferably 3.4 mJ/pulse or more and 8 mJ/pulse or less.

In the first means and second means of the present invention, a wavelength of the laser beam is preferably 5 μm or more and 11 μm or less.

For example, it is possible to use a CO laser beam source (oscillation wavelength: 5 μm) or a CO₂ laser beam source (oscillation wavelength: 9.3 to 10.6 μm) as a laser beam source that pulses a laser beam having a wavelength as described above.

In the first means and second means of the present invention, a cut form of the plastic film is not limited to a full cut. The cut form of the plastic film may be a half cut.

In the first means and second means of the present invention, the plastic film is preferably cut in a free-form shape by two-dimensionally scanning the laser beam and the plastic film relative to each other.

As a mode for two-dimensionally scanning a laser beam and a plastic film relative to each other, for example, it is conceivable to place and fix (for example, fix by suction) a sheet-like plastic film on an X-Y dual-axis stage, and then drive the X-Y dual-axis stage to change the relative position on the X-Y two-dimensional plane of the plastic film with respect to the laser beam. Further, it is also conceivable to change the position on the X-Y two-dimensional plane of the laser beam with which the plastic film is irradiated, by fixing the position of the plastic film and deflecting the laser beam oscillated from the laser beam source using a galvanometer mirror or a polygon mirror. In addition, it is possible to combine use of both the aforementioned scanning of a plastic film using an X-Y dual-axis stage and scanning of a laser beam using a galvanometer mirror or the like.

Further, in a case where the plastic film is raw film that is wound in a roll shape and the plastic film is cut continuously by a so-called “roll-to-roll system”, as a mode for two-dimensionally scanning a laser beam and a plastic film relative to each other, for example, it is conceivable to place and fix a laser beam source on an X-Y dual-axis stage, and then drive the X-Y dual-axis stage to change the position on an X-Y two-dimensional plane of the laser beam with which the plastic film is irradiated. In addition, it is possible to combine use of both the aforementioned scanning of a laser beam source using an X-Y dual-axis stage, and scanning of a laser beam using a galvanometer mirror or the like.

According to the first means and second means of the present invention, it is possible to obtain a plastic film in which at least a protective film, an adhesive and a base material are laminated in that order, wherein a width of contamination caused by components derived from the adhesive that adhere to the protective film surface is 0.3 mm or less.

In the plastic film, a thickness of the adhesive is preferably 20 μm or less.

For example, the plastic film is a polarizing film.

### Advantageous Effects of Invention

According to the present invention, it is possible to easily reduce contamination of a plastic film surface that is caused by adherence to the plastic film surface of scattered matter that arises when performing laser processing of the plastic film, and it is also possible to cut a plastic film in a free-form shape.

### BRIEF DESCRIPTION OF DRAWINGS

FIG. 1 is a diagram that schematically illustrates one example of a laser processing apparatus used in a laser processing method according to one embodiment of the present invention.

FIG. 2 FIGS. 2A to 2C are diagrams that schematically illustrate cross sections of plastic films used in tests according to Examples and Comparative Examples.

FIG. 3 is an explanatory drawing for describing a method for evaluating the contamination of a plastic film surface.

FIG. 4 is a table showing various conditions of laser processing methods according to Examples and Comparative Examples, and contamination widths W that were evaluated.

### DESCRIPTION OF EMBODIMENTS

Hereunder, a laser processing method for a plastic film according to one embodiment of the present invention is described with reference being made as appropriate to the attached drawings.

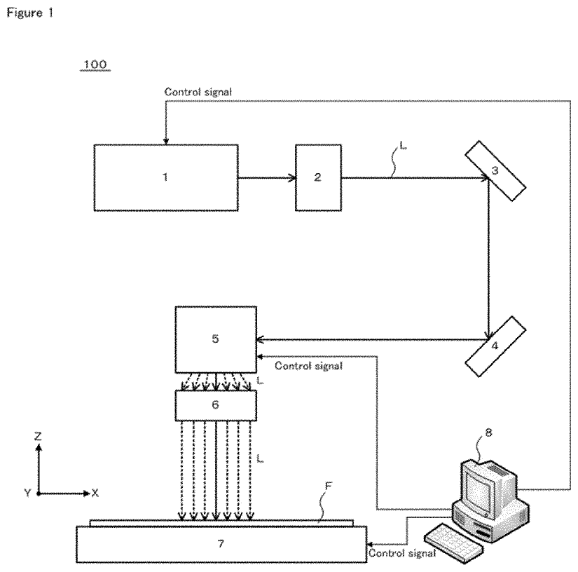

FIG. 1 is a diagram that schematically illustrates one example of a laser processing apparatus used in a laser processing method according to one embodiment of the present invention.

As illustrated in FIG. 1, a laser processing apparatus 100 of the present embodiment includes a laser beam source 1, an optical element 2, reflection mirrors 3 and 4, a galvanometer mirror 5, a telecentric fθ lens 6, an X-Y dual-axis stage 7 and a control device 8.

Although the laser beam source 1 is not particularly limited as long as it is a laser beam source that pulses a laser beam L having a wavelength in the infrared region, preferably a laser beam source is used in which the wavelength of the laser beam L that is pulsed from the laser beam source 1 is 5 μm or more and 11 μm or less. Specifically, a CO laser beam source (oscillation wavelength: 5 μm) or a CO₂ laser beam source (oscillation wavelength: 9.3 to 10.6 μm) is used. In the case of using a CO laser beam source, the optical path of the laser beam L may be purged using an inert gas such as nitrogen.

The optical element 2 is constituted by various optical components such as an acousto-optic modulator (AOM) for controlling the power (intensity) of the laser beam L, an expander or condenser lens or aperture for condensing the laser beam L, and a homogenizer for flattening the spatial beam profile of the laser beam L.

The laser beam L that is oscillated from the laser beam source 1 and passes through the optical element 2, is reflected and deflected at the reflection mirrors 3 and 4, respectively, and is incident on the galvanometer mirror 5.

The laser beam L incident on the galvanometer mirror 5 is reflected and deflected by the galvanometer mirror 5 to be incident on the telecentric fθ lens 6. The galvanometer mirror 5 is capable of changing the deflection direction of the reflected laser beam L by pivoting. In the example illustrated in FIG. 1, the deflection direction of the laser beam L is changed in the X-direction of an X-Y two-dimensional plane (the deflection direction of the laser beam L indicated by the arrow mark of the straight line in FIG. 1 is sequentially changed to the deflection directions indicated by the arrow marks of the dashed lines) by the galvanometer mirror 5. That is, the laser beam L is scanned in the X-direction.

The laser beam L that is incident from the galvanometer mirror 5 and exits from the telecentric fθ lens 6 is emitted onto a plastic film F from a direction perpendicular to the surface of the plastic film F at each of the scanning positions in the X-direction, and is also emitted with a uniform spot diameter at each of the scanning positions.

The plastic film F is placed on and fixed (fixed by suction) to the X-Y dual-axis stage 7, and the X-Y dual-axis stage 7 changes the position on the X-Y two-dimensional plane of the plastic film F.

The control device 8 of the present embodiment coordinates and controls the galvanometer mirror 5 and the X-Y dual-axis stage 7. Specifically, a desired cutting shape of the plastic film F is input in advance into the control device 8. The control device 8 outputs a control signal for cutting the plastic film F in accordance with the input cutting shape (scanning the laser beam L at cutting positions in accordance with the desired cutting shape), to the galvanometer mirror 5 and the X-Y dual-axis stage 7. The galvanometer mirror 5 and the X-Y dual-axis stage 7 each operate in accordance with the input control signal, and the laser beam L is sequentially scanned at the cutting positions of the plastic film F in accordance with the desired cutting shape by co-operation between the galvanometer mirror 5 and the X-Y dual-axis stage 7.

Further, the control device 8 outputs a control signal to the laser beam source 1 to control settings with respect to the on/off timing, repetition frequency, and power of the laser beam L that is oscillated from the laser beam source 1.

A laser processing method according to the present embodiment that uses the laser processing apparatus 100 having the above configuration is described hereunder.

The laser processing method according to the present embodiment includes a process of pulsing the laser beam L from the laser beam source 1 and causing the plastic film F to be irradiated with the laser beam L to thereby cut the plastic film F. At such time, by the control device 8 controlling the galvanometer mirror 5 and the X-Y dual-axis stage 7, the laser beam L and the plastic film F are two-dimensionally scanned relative to each other so that the plastic film F is cut into a desired free-form shape. The cut form with respect to the plastic film F is not limited to a full cut, and it is also possible to adopt a half cut as the cut form.

Examples of the plastic film F that is the cutting object in the laser processing method according to the present embodiment include a single-layer film or a laminated film composed of multiple layers which is formed of polyethylene terephthalate (PET), polyethylene (PE), polypropylene (PP), an acrylic resin such as polymethyl methacrylate (PMMA), a cyclic olefin polymer (COP), a cyclic olefin copolymer (COC), a polycarbonate (PC), a urethane resin, a polyvinyl alcohol (PVA), a polyimide (PI), polytetrafluoroethylene (PTFE), polyvinyl chloride (PVC), polystyrene (PS), triacetylcellulose (TAC), polyethylene naphthalate (PEN), ethylene vinyl acetate (EVA), a polyamide (PA), a silicone resin, an epoxy resin, a liquid crystal polymer, or a plastic material such as various kinds of resin foam.

The plastic film F adopted as the cutting object in the laser processing method according to the present embodiment preferably has an absorptivity of 15% or more with respect to the wavelength of the laser beam L with which it is irradiated.

In a case where the plastic film F is a laminated film composed of multiple layers, various kinds of adhesive such as acrylic adhesive, urethane adhesive, or silicone adhesive, or a bonding agent may be interposed between the layers.

Further, an electroconductive inorganic membrane composed of indium tin oxide (ITO), Ag, Au, or Cu or the like may be formed on the surface of the plastic film F.

The laser processing method according to the present embodiment is favorably used for various kinds of optical films such as a polarizing film or a phase contrast film to be particularly used in a display.

The thickness of the plastic film F is preferably made to fall within the range of 20 to 500 μm. Regarding the form of the plastic film F, the plastic film F may be in a sheet-like form as in the present embodiment or may be in the form of a raw film that is wound in a roll shape.

In the laser processing method according to the present embodiment, the peak energy density of the laser beam L oscillated from the laser beam source 1 and causing the plastic film F to be irradiated with the laser beam L (peak energy density at the irradiated position on the film F) is set to 70 J/cm² or more and 270 J/cm² or less. Further, the pulse energy of the laser beam L with which the plastic film F is irradiated (pulse energy at the irradiated position on the film F) is set to 3.4 mJ/pulse or more and 8 mJ/pulse or less. The optical components such as the AOM constituting the optical element 2 are adjusted so that the aforementioned peak energy density and pulse energy are obtained.

In the laser processing method according to the present embodiment, the control device 8 controls the galvanometer mirror 5 and the X-Y dual-axis stage 7 so that a shot pitch of the laser beam L is smaller than the spot diameter on the plastic film F of the laser beam L. The shot pitch is a value obtained by dividing the scanning speed of the laser beam L (relative movement speed between the laser beam L and the plastic film F) by the repetition frequency (equivalent to the number of pulses of the oscillated laser beam L per unit time), and means the interval between a laser beam L emitted by a certain pulsing and a laser beam L emitted by the next pulsing.

Hereunder, examples of results of tests in which a plastic film F was cut using laser processing methods according to the present embodiment (Examples) and Comparative Examples are described.

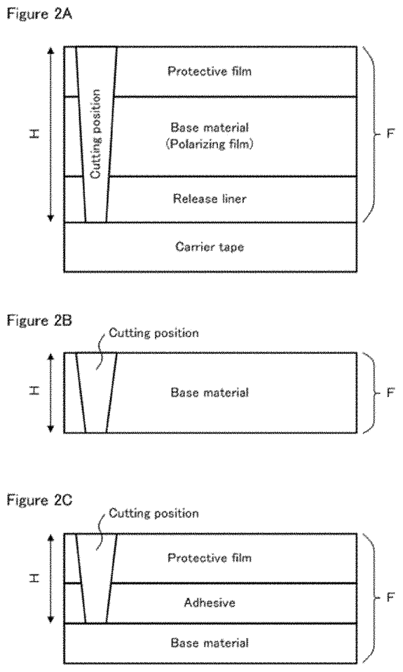

FIGS. 2A to 2C are diagrams that schematically illustrate cross sections of plastic films F used in tests according to the Examples and Comparative Examples. FIG. 2A illustrates the cross section of a plastic film F to which laser processing methods according to Examples 1 to 13 and Comparative Examples 1 and 2 were applied. FIG. 2B illustrates the cross section of a plastic film F to which laser processing methods according to Examples 14 and 15 were applied. FIG. 2C illustrates the cross section of a plastic film F to which laser processing methods according to Examples 16 and 17 were applied.

As illustrated in FIG. 2A, as the plastic film F of Examples 1 to 13 and Comparative Examples 1 and 2, a laminated film was used in which, in order from the top (in order from the side irradiated with the laser beam L), a protective film, a base material and a release liner were laminated. A carrier tape for conveying was attached to the undersurface of the laminated film F, and the laminated film F was subjected to half-cut processing that cut the laminated film F except for the carrier tape.

Polyethylene terephthalate (PET) was used as the material for forming the protective film, and an acrylic adhesive (not illustrated) was applied to the undersurface of the protective film. A polarizing film was used as the base material. A laminated film composed of triacetylcellulose (TAC) and polyvinyl alcohol (PVA) was used as the polarizing film, and an acrylic adhesive (not illustrated) was applied to the undersurface of the polarizing film. Polyethylene terephthalate (PET) was used as the material for forming the release liner, and an acrylic adhesive (not illustrated) was applied to the top surface of the release film. Polyethylene terephthalate (PET) was used as the material for forming the carrier tape, and an acrylic adhesive (not illustrated) was applied to the top surface of the carrier tape.

As illustrated in FIG. 2B, a single-layer film composed of only a base material was used as the plastic film F in Examples 14 and 15, and full-cut processing to cut the single-layer film was performed. A single-layer film formed from polyimide (PI) was used as the plastic film F in Example 14. A single-layer film formed from polypropylene (PP) was used as the plastic film F in Example 15.

As illustrated in FIG. 2C, as the plastic film F in Examples 16 and 17, a laminated film was used in which, in order from the top (in order from the side irradiated with the laser beam L), a protective film, an adhesive and a base material were laminated. The laminated film F was subjected to half-cut processing that cut the protective film and adhesive of the laminated film F. A protective film that was the same as in Examples 1 to 13 and Comparative Examples 1 and 2 was used. Polyethylene terephthalate (PET) was used as the material for forming the base material of Examples 16 and 17. Instead of the acrylic adhesive used in Examples 1 to 13 and Comparative Examples 1 and 2, a urethane adhesive was used as the adhesive in Example 16. Instead of the acrylic adhesive used in Examples 1 to 13 and Comparative Examples 1 and 2, a silicone adhesive was used as the adhesive in Example 17.

Each of the plastic films F described above was subjected to a cutting process to cut the plastic film F into a rectangular shape of 50 mm×50 mm using a CO₂ laser beam source (oscillation wavelength: 9.4 μm) as the laser beam source 1, under a condition whereby the peak energy density of the laser beams L with which the respective plastic films F was irradiated was changed to various values.

Contamination of the surface of each plastic film F after cutting was then evaluated.

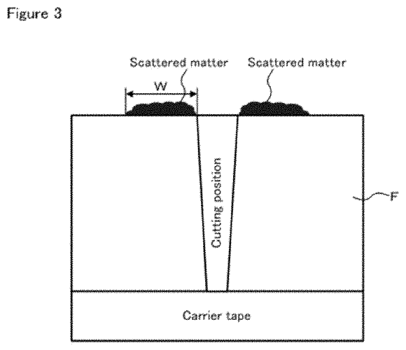

FIG. 3 is an explanatory drawing for describing the method for evaluating contamination of the surface of the plastic film F.

As illustrated in FIG. 3, the surface of the plastic film F (surface on the side irradiated with the laser beam L) was observed using an optical microscope, and the length (maximum length) to which scattered matter was adhered from the edge of the cutting position was measured and taken as a contamination width W.

Although the plastic film F shown in FIG. 2A is illustrated in FIG. 3, the contamination width W was also measured by the same method for the plastic films F shown in FIG. 2B and FIG. 2C.

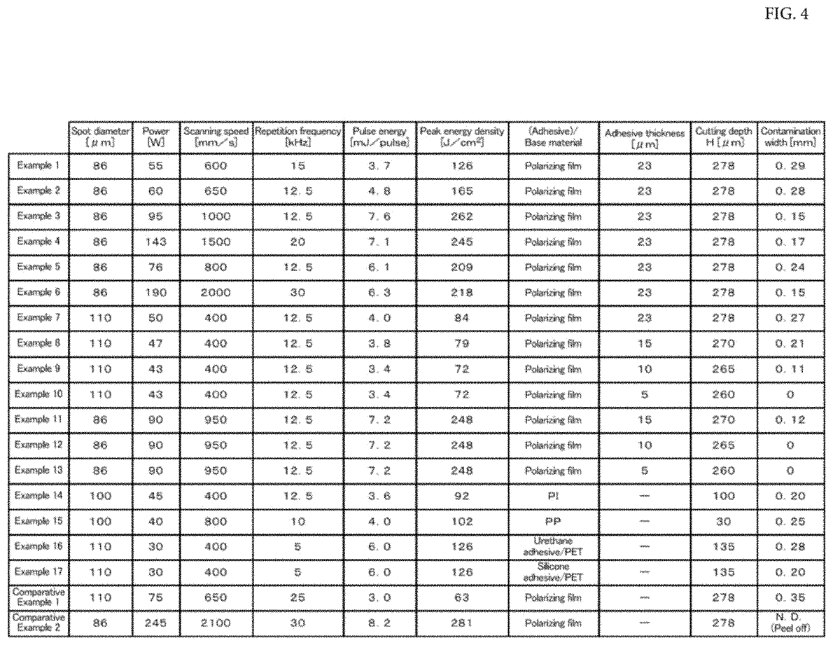

FIG. 4 is a table showing various conditions of the laser processing methods according to the Examples and Comparative Examples, as well as the contamination widths W that were evaluated. Note that, the numerical value described in the “Adhesive thickness” column shown in FIG. 4 means the thickness of an acrylic adhesive applied to the undersurface of the protective film (acrylic adhesive applied between the protective film and the base material).

As illustrated in FIG. 4, in Examples 1 to 17, by setting the peak energy density of the laser beam L with which the plastic film F is irradiated to a value of 70 J/cm² or more and 270 J/cm² or less, the contamination width W was reduced to 0.3 mm or less that is the upper limit value of the specification. Further, in Examples 8 to 13, because the thickness of the adhesive (acrylic adhesive) that was applied between the protective film and the base material was 20 μm or less, the contamination width W was decreased to 0.3 mm or less. Further, the thinner the thickness of the adhesive was, the smaller the contamination width W became.

In contrast, in Comparative Example 1, because the peak energy density was less than 70 J/cm², the contamination width W was more than 0.3 mm. Further, in Comparative Example 2, because the peak energy density was more than 270 J/cm², a state was entered in which the protective film peeled off from the polarizing film that was the base material.

As described above, according to the laser processing method according to the present embodiment, because the peak energy density of the laser beam L with which the plastic film F is irradiated is 70 J/cm² or more, a temperature increase accompanying infrared absorption of the plastic film F is activated. By this means, the kinetic energy of scattered matter that arises when the plastic film F melts and gasifies increases, and it is possible to reduce scattered matter that adheres to the surface of the plastic film F in the vicinity of the cutting position. As a result, contamination of the surface of the plastic film F can be reduced.

Further, according to the laser processing method according to the present embodiment, because the peak energy density of the laser beam L with which the plastic film F is irradiated is 270 J/cm² or less, there is no risk of the laser beam L leading to a decrease in the quality of the end face of the plastic film F at the cutting position.

### REFERENCE SIGNS LIST

1 Laser Beam Source
2 Optical Element
3, 4 Reflection Mirror
5 Galvanometer Mirror
6 Telecentric fθ Lens
7 X-Y Dual-axis Stage
8 Control Device
100 Laser Processing Apparatus
F Plastic Film
L Laser Beam

1. A laser processing method for a plastic film, comprising:
a process of pulsing a laser beam having a wavelength in an infrared region and causing a plastic film to be irradiated with the laser beam to cut the plastic film,
wherein a peak energy density of the laser beam with which the plastic film is irradiated is 70 J/cm² or more and 270 J/cm² or less.

2. The laser processing method for a plastic film according to claim 1, wherein:
a pulse energy of the laser beam with which the plastic film is irradiated is 3.4 mJ/pulse or more and 8 mJ/pulse or less.

3. A laser processing method for a plastic film comprising:
a process of, with respect to a plastic film in which at least a protective film, an adhesive and a base material are laminated in that order, pulsing a laser beam having a wavelength in an infrared region from the protective film side and causing the plastic film to be irradiated with the laser beam to cut the plastic film,
wherein a thickness of the adhesive is 20 μm or less.

4. The laser processing method for a plastic film according to claim 1, wherein:
a wavelength of the laser beam is 5 μm or more and 11 μm or less.

5. The laser processing method for a plastic film according to claim 1, wherein:
a cut form of the plastic film is a full cut or a half cut.

6. The laser processing method for a plastic film according to claim 1, wherein:
the plastic film is cut in a free-form shape by two-dimensionally scanning the laser beam and the plastic film relative to each other.

7. A plastic film in which at least a protective film, an adhesive and a base material are laminated in that order,
wherein a width of contamination caused by components derived from the adhesive that adhere to the protective film surface is 0.3 mm or less.

8. The plastic film according to claim 7, wherein:
a thickness of the adhesive is 20 μm or less.

9. The plastic film according to claim 7, wherein:
the plastic film is a polarizing film.

10. The plastic film according to claim 8, wherein:
the plastic film is a polarizing film.

11. The laser processing method for a plastic film according to claim 2, wherein:
a wavelength of the laser beam is 5 μm or more and 11 μm or less.

12. The laser processing method for a plastic film according to claim 2, wherein:
a cut form of the plastic film is a full cut or a half cut.

13. The laser processing method for a plastic film according to claim 2, wherein:
the plastic film is cut in a free-form shape by two-dimensionally scanning the laser beam and the plastic film relative to each other.

14. The laser processing method for a plastic film according to claim 3, wherein:
a wavelength of the laser beam is 5 μm or more and 11 μm or less.

15. The laser processing method for a plastic film according to claim 3, wherein:
a cut form of the plastic film is a full cut or a half cut.

16. The laser processing method for a plastic film according to claim 3, wherein:
the plastic film is cut in a free-form shape by two-dimensionally scanning the laser beam and the plastic film relative to each other.
